(19) United States
(12) Patent Application Publication
(10) Pub. No.: US 2019/0146130 A1
(43) Pub. Date: May 16, 2019

(54) REFLECTIVE DISPLAY DEVICE AND METHOD OF MANUFACTURING REFLECTIVE DISPLAY DEVICE

(71) Applicant: Samsung Display Co., Ltd., Yongin-si (KR)

(72) Inventors: Eun Ae Kwak, Gunpo-si (KR); Min Uk Kim, Daejeon (KR); Jun Ho Song, Seongnam-si (KR); Young Je Cho, Hwaseong-si (KR)

(21) Appl. No.: 16/189,448

(22) Filed: Nov. 13, 2018

(30) Foreign Application Priority Data
Nov. 14, 2017 (KR) 10-2017-0151360

(51) Int. Cl. G02B 5/20; G02B 5/30; G02B 1/00

(52) U.S. Cl. CPC G02B 5/201; G02F 1/133528; G02B 1/005; G02B 5/3058

(57) ABSTRACT

A reflective display and method of manufacturing reflective display device, the reflective display device including a first substrate, a polarization layer disposed on the first substrate and including a plurality of wire patterns, and a photonic crystal unit including a plurality of nanopatterns arranged over the first substrate at predetermined pitches. As a result, a reflective display device may provide an excellent contrast ratio and an excellent color reproducibility.

### CROSS REFERENCE TO RELATED APPLICATION

This application claims priority from and the benefit of Korean Patent Application No. 10-2017-0151360, filed on Nov. 14, 2017, which is hereby incorporated by reference for all purposes as if fully set forth herein.

### BACKGROUND

### Field

Exemplary embodiments of the invention relate generally to a reflective display device and a method of manufacturing a reflective display device.

### Discussion of the Background

Without their own light source, achieving high brightness, contrast, and color reproducibility in the development of color reflective displays has been a challenge. This has been difficult because light efficiency is too low when using a Red/Green/Blue color filters such as that used in the conventional LCD structure. The typical color reflective display, therefore, now comprises three layers that generate red, green and blue light, each separated by a sheet of substrate with transparent electrode. Such displays typically lack good contrast ratios and color reproducibility.

The above information disclosed in this Background section is only for understanding of the background of the inventive concepts, and, therefore, it may contain information that does not constitute prior art.

### SUMMARY

Exemplary embodiments of the present invention provide a reflective display device having an excellent contrast ratio.

Exemplary embodiments of the present invention provide a reflective display device having excellent color reproducibility.

Additional features of the inventive concepts will be set forth in the description which follows, and in part will be apparent from the description, or may be learned by practice of the inventive concepts.

According to an exemplary embodiment, a reflective display device may include: a first substrate; a polarization layer disposed on the first substrate and including a plurality of wire patterns; and a photonic crystal unit including a plurality of nanopatterns arranged over the first substrate at predetermined pitches.

The reflective display device may further include a first insulation film covering the polarization layer, and the photonic crystal unit may be disposed on the first insulation film.

The photonic crystal unit may include a red photonic crystal unit, a green photonic crystal unit, and a blue photonic crystal unit.

The red photonic crystal unit may include a plurality of first nanopatterns arranged to have a first pitch, the green photonic crystal unit may include a plurality of second nanopatterns arranged to have a second pitch, and the blue photonic crystal unit may include a plurality of third nanopatterns arranged to have a third pitch.

The first pitch may be 380 nm to 450 nm, the second pitch may be 300 nm to 350 nm, and the third pitch may be 250 nm or more and less than 300 nm.

The heights of the first nanopattern, the second nanopattern, and the third nanopattern may be different from each other.

The red photonic crystal unit may transmit light having a red wavelength, the green photonic crystal unit may transmit light having a green wavelength, and the blue photonic crystal unit may transmit light having a blue wavelength.

The nanopattern may have a thickness of 150 nm to 300 nm.

The nanopattern may have a bar shape extending in one direction.

The nanopatterns may be arranged in a matrix form having a plurality of rows and a plurality of columns.

The nanopattern may be formed by engraving.

The reflective display device may further include: a second substrate facing the first substrate; and a polarization plate formed on the second substrate. The polarization directions of the polarization plate and the polarization layer may be different from each other.

The reflective display device may further include: a color filter disposed over the first substrate. The color filter may overlap the photonic crystal unit.

The wire patterns and the photonic crystal unit may be disposed on the same layer.

The reflective display device may further include: a reflective layer disposed beneath the first substrate.

According to another exemplary embodiment, a method of manufacturing a reflective display device may include: forming or otherwise disposing a material layer over a substrate provided with a polarization layer including a plurality of wire patterns; applying an imprint resin onto the material layer; pressing the imprint resin using a mask mold including a first protrusion, a second protrusion, and a third protrusion having different pitches from each other to pattern the imprint resin; etching the patterned imprint resin to form a resin mask; and etching the material layer using the resin mask as an etch stop film to form a photonic crystal unit.

The resin mask may include a first mask having a first pitch, a second mask having a second pitch, and a third mask having a third pitch.

According to still another exemplary embodiment, a method of manufacturing a reflective display device may include: forming or otherwise disposing a material layer on a first substrate; applying an imprint resin onto the material layer; pressing the imprint resin using a mask mold including a first protrusion, a second protrusion, and a third protrusion having different pitches from each other to pattern the imprint resin; etching the patterned imprint resin to form a resin mask; and etching the material layer using the resin mask as an etch stop film to form a photonic crystal unit and wire patterns.

The method may further include: forming or otherwise disposing a reflective layer beneath the first substrate.

The resin mask may include a first mask having a first pitch, a second mask having a second pitch, a third mask having a third pitch, and a fourth mask having a fourth pitch.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a layout diagram of a reflective display device according to an exemplary embodiment of the present invention.

FIG. 2 is an enlarged view of the region “A” of FIG. 1.

FIG. 3 is a sectional view taken along the line I-I′ of FIG. 2.

FIG. 4 is a sectional view taken along the line II-II′ of FIG. 1.

FIG. 5 is a partial perspective view of a reflective display device according to another exemplary embodiment.

FIG. 6 is a partial perspective view of a reflective display device according to another exemplary embodiment.

FIG. 7 is a partial perspective view of a reflective display device according to another exemplary embodiment.

FIG. 8 is a partial perspective view of a reflective display device according to another exemplary embodiment.

FIG. 9 is a sectional view of a reflective display device according to another exemplary embodiment.

FIGS. 10, 11, 12, 13, 14, 15, and 16 are sectional views illustrating a method of manufacturing a reflective display device according to an exemplary embodiment of the present invention.

FIGS. 17, 18, 19, and 20 are sectional views illustrating a method of manufacturing a reflective display device according to another exemplary embodiment of the present invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

A photonic crystal color filter controls the reflection or absorption of light incident from the outside using a nanostructure having a size smaller than the wavelength of light, thereby reflecting (or transmitting) light of a desired color and transmitting (or reflecting) light of other colors. Such a photonic crystal color filter has a structure in which nanosized unit blocks are periodically arranged at regular intervals. Since the optical characteristics of the photonic crystal color filter are determined depending on its structure, when the photonic crystal color filter is fabricated to have a structure suitable for a specific wavelength, there are advantages that wavelength selectivity is excellent and a color band is easily controlled. In addition, due to such characteristics, the photonic crystal color filter can be more usefully applied to a reflective liquid crystal display device that uses external light having a very wide spectrum distribution.

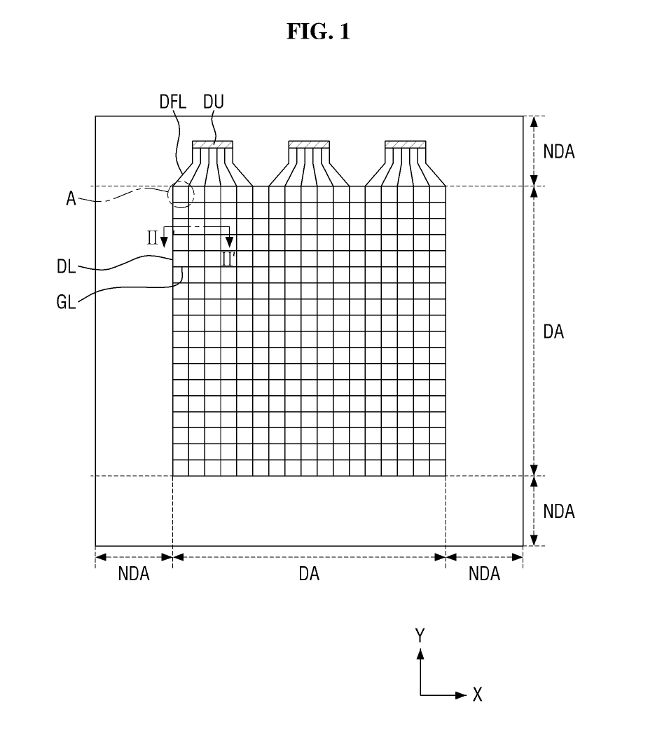

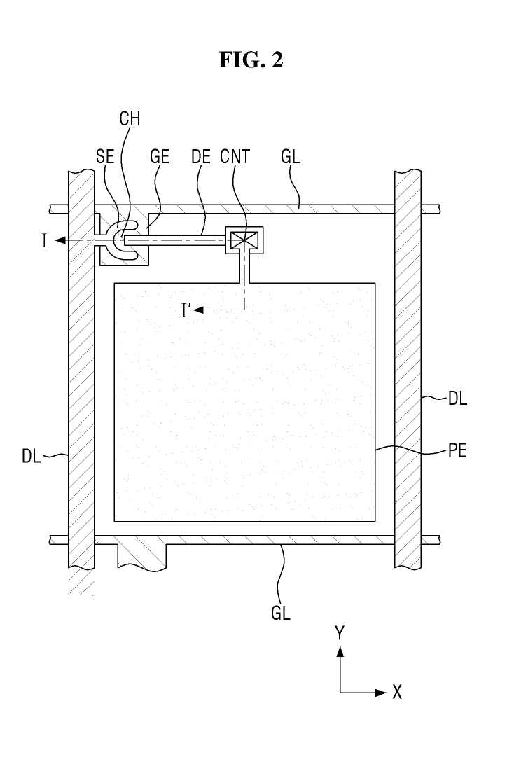

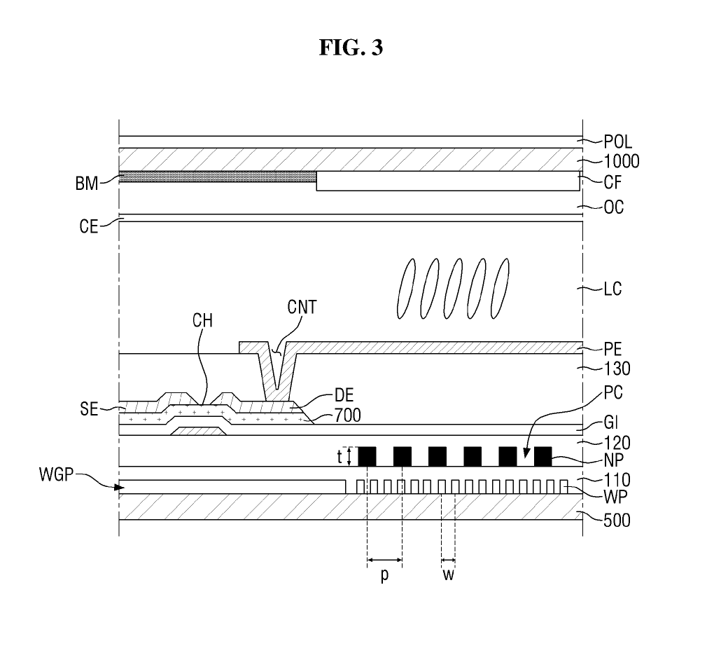

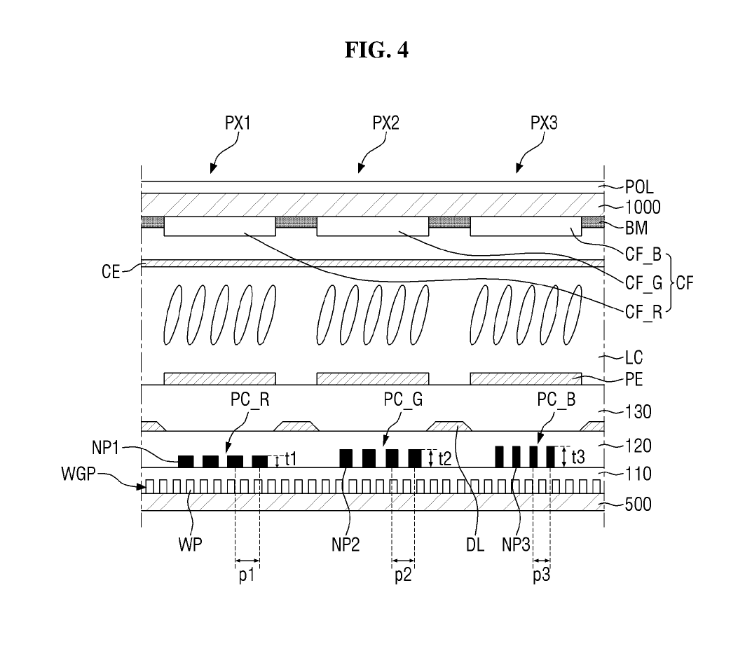

FIG. 1 is a layout diagram of a reflective display device according to an exemplary embodiment of the present invention. FIG. 2 is an enlarged view of the region “A” of FIG. 1. FIG. 3 is a sectional view taken along the line I-I′ of FIG. 2. FIG. 4 is a sectional view taken along the line II-II′ of FIG. 1.

Referring to FIGS. 1 to 4, a reflective display device according to an exemplary embodiment includes a first substrate 500, a polarization layer WGP disposed on the first substrate 500 and including a plurality of wire patterns WP, and a photonic crystal unit PC including a plurality of nanopatterns NP arranged over the first substrate 500 at predetermined pitches.

The first substrate 500 may be formed of a material having heat resistance and light-transmitting properties. For example, the first substrate 500 may be formed of transparent glass or plastic, but the present invention is not limited thereto. A display area DA and a non-display area NDA may be defined on the first substrate 500 (refer to FIG. 1).

In the display device, the display area DA is an area on which an image is displayed, and the non-display area NDA is an area in which various signal lines are arranged in order to display an image on the display area DA.

A plurality of data drivers DU providing data signals to data lines DL and a plurality of data fanout lines DFL transmitting the signals provided from the data drivers DU to the data lines DL may be arranged on the non-display area NDA.

More specifically explaining the display area DA, a plurality of pixels obtained by intersecting a plurality of data lines DL and a plurality of gate lines GL each other may be arranged on the display area DA. That is, FIG. 2 is an enlarged view of one pixel (region “A” of FIG. 1) of the plurality of pixels, and the display area DA may include a plurality of substantially the same as these pixels.

Subsequently, the sectional shape of the reflective display device according to an embodiment will be described with reference to FIG. 3.

The polarization layer WGP may be disposed on the first substrate 500. In the reflective display device, the polarization layer WGP may reflect at least a part of external light. Specifically, in the light provided from the outside, light vibrating in one direction can be transmitted, and light vibrating in the other direction can be reflected.

In an embodiment, the polarization layer WGP may include a plurality of wire patterns WP extending in one direction. One wire pattern WP may have a line shape extending in one direction. The plurality of wire patterns WP may be arranged to be spaced apart from each other and parallel to each other.

The plurality of wire patterns WP may have reflective polarization characteristics. In this specification, the “reflective polarized light characteristic’ means that a polarization component vibrating in a direction parallel to a transmission axis is transmitted, and a polarization component vibrating in a direction crossing the transmission axis is partially reflected, so as to impart polarization characteristics to the transmitted light.

For example, in external light, the polarization component vibrating in a direction substantially parallel to the extending direction of the wire patterns WP may be reflected, and the polarization component vibrating in a direction perpendicular to the extending direction of the wire patterns WP may be transmitted.

In an embodiment, the wire pattern WP may be made of a material that is easy to process and has excellent light reflectance. Specifically, the wire pattern WP may be made of a metallic material or a non-metallic material. Examples of the metallic material may include aluminum (Al), silver (Ag), gold (Au), copper (Cu), titanium (Ti), molybdenum (Mo), oxides thereof, and alloys thereof. Examples of the non-metallic material may include silicon oxide, silicon nitride, silicon oxynitride, and silicon nitroxide.

In an embodiment, the width of the wire pattern WP may be greater than or equal 20 nm and less than or equal to 80 nm. Further, the plurality of wire patterns WP may be arranged to have a predetermined pitch w. In an embodiment, the pitch w of the plurality of wire patterns WP may be equal to or greater than 80 nm and less than or equal to 500 nm.

In an embodiment, the thickness of the wire pattern WP may be greater than or equal to 1,000 Å and less than or equal to 2,500 Å.

A first insulation film 110 may be disposed on the polarization layer WGP. In an embodiment, the first insulation film 110 may completely cover the polarization layer WGP. The upper surface of the first insulation film 110 covering the polarization layer WGP may be substantially flat. That is, the first insulation film may serve as a planarization film.

In an embodiment, the first insulation film 110 may be made of a non-metallic inorganic material and/or an organic material. The non-metallic inorganic material may be, for example, silicon oxide, silicon nitride, silicon oxynitride, or silicon nitroxide.

The organic material may be, for example, an epoxy resin, an acrylic resin, a cardo type resin, or an imide resin.

The first insulation film 110 may be formed of one selected from the above materials, or may be formed of a mixture of two or more selected therefrom.

Although FIG. 3 illustrates a case where the first insulation film 110 is a single film, the structure of the first insulation film 110 is not limited thereto. In another embodiment, the first insulation film 110 may have a structure in which two or more layers are laminated.

The photonic crystal unit PC may be formed on the first insulation film 110. The photonic crystal unit PC may be at least partially formed on the first insulation film 110. The photonic crystal unit PC may include a plurality of nanopatterns NP. The nanopattern NP may be an engraved or embossed pattern having a nanosize (FIG. 3 illustrates a case where the nanopattern NP is an embossed pattern). The plurality of nanopatterns NP may have a predetermined pitch p and may be spaced apart from each other. In this specification, the “pitch” may refer to a distance between the center of one nanopattern NP and the center of another adjacent nanopattern NP (refer to FIG. 3). The center may be a geometric center. The geometric center may be a point or line depending on the shape of the nanopattern (NP).

In an embodiment, the pitch p may be 250 nm to 450 nm. The pitch of the plurality of nanopatterns NP may determine the wavelength of light transmitted through the photonic crystal unit PC. That is, the nanopatterns (NP) having a predetermined pitch may selectively transmit only light of a desired color among reflected external light. In this case, the light transmitted through the photonic crystal unit PC may have any one of red, green and blue colors. The pitch p and shape of the nanopattern NP corresponding to each color will be described in detail later.

In an embodiment, the thickness t of the nanopattern NP may be 150 nm to 300 nm. Similarly to the above pitch, the thickness of the nanopatern NP may differ depending on the corresponding color.

In an embodiment, the nanopattern NP may be made of a metal material and/or a non-metallic inorganic material. The nanopattern NP may include, for example, any one or more materials selected from Si, SiC, ZnS, AlN, BN, GaTe, AgI, TiO₂, and SiON.

A second insulation film 120 may be disposed on the nanopatterns NP. The second insulation film 120 may cover the nanopatterns NP.

The second insulation film 120 may be made of a non-metallic inorganic material and/or an organic material. The non-metallic inorganic material may be, for example, silicon oxide, silicon nitride, silicon oxynitride, or silicon nitroxide.

The organic material may be, for example, an epoxy resin, an acrylic resin, a cardo type resin, or an imide resin.

The second insulation film 120 may be formed of one selected from the above materials, or may be formed of a mixture of two or more selected therefrom.

Although FIG. 3 illustrates a case where the second insulation film 120 is a single film, the structure of the second insulation film 120 is not limited thereto. In another embodiment, the second insulation film 120 may have a structure in which two or more layers are laminated.

A gate wiring (GL, GE) may be disposed on the second insulation film 120. The gate wiring (GL, GE) may include a gate line GL receiving a signal necessary for driving and a gate electrode GE protruding from the gate line GL. The gate line GL may extend in a first direction. The first direction may be substantially the same as the X-axis direction of FIG. 2. The gate electrode GE may constitute the three terminals of a thin film transistor together with a source electrode SE and a drain electrode DE to be described later.

The gate wiring (GL, GE) may include one or more of aluminum (Al)-based metal including an aluminum alloy, silver (Ag)-based metal including a silver alloy, copper (Cu)-based metal including a copper alloy, molybdenum (Mo)-based metal including a molybdenum alloy, chromium (Cr), titanium (Ti), and tantalum (Ta). However, this is illustrative example, and the material of the gate wiring (GL, GE) is not limited thereto. Metals or polymer materials having performance required to realize a desired display device may be used as the material of the gate wiring (GL, GE).

The gate wiring (GL, GE) may have a single film structure, but is not limited thereto, and may have a double film structure, a triple film structure, or a multiple film structure.

A gate insulation film GI may be disposed on the gate wiring (GL, GE). The gate insulation film GI may cover the gate wiring (GL, GE), and may be formed over the entire surface of the first substrate 500.

The gate insulation film GI may be formed of any one selected from inorganic insulation materials such as silicon oxides (SiOx) and silicon nitrides (SiNx) and organic insulation materials such as benzocyclobutene (BCB), acrylic materials and polyimide, or may be formed of a mixture of two or more selected therefrom.

A semiconductor pattern layer 700 may be disposed on the gate insulation film GI.

The semiconductor pattern layer 700 may include amorphous silicon or polycrystalline silicon. However, the present invention is not limited thereto, and the semiconductor pattern layer 700 may include an oxide semiconductor.

The semiconductor pattern layer 700 may have various shapes such as an island shape and a linear shape. When the semiconductor pattern layer 700 has a linear shape, the semiconductor pattern layer 700 may be disposed under the data line DL and extend to the top of the gate electrode GE.

In an embodiment, the semiconductor pattern layer 700 may be patterned in substantially the same shape as a data wiring (DL, SE, DE) to be described later in all regions except a channel region CH.

In other words, the semiconductor pattern layer 700 may be disposed to overlap the data wiring (DL, SE, DE) in all regions except the channel region CH.

The channel region CH may be disposed between the source electrode SE and the drain electrode DE, which face each other. The channel region CH serves to electrically connect the source electrode SE and the drain electrode DE, and the specific shape thereof is not limited.

An ohmic contact layer (not shown) doped with n-type impurities at high concentration may be disposed on the semiconductor pattern layer 700. The ohmic contact layer may overlap whole or a part of the semiconductor pattern layer 700. However, in an embodiment in which the semiconductor pattern layer 700 includes an oxide semiconductor, the ohmic contact layer may be omitted.

When the semiconductor pattern layer 700 is an oxide semiconductor layer, the semiconductor pattern layer 700 may include zinc oxide (ZnO). In addition, the semiconductor pattern layer 700 may be doped thereon with ions of one or more selected from the group consisting of gallium (Ga), indium (In), stannum (Sn), zirconium (Zr), hafnium (Hf), cadmium (Cd), silver (Ag), copper (Cu), germanium (Ge), gadolinium, Titanium (Ti), and vanadium (V). Illustratively, the semiconductor pattern layer 700, which is an oxide semiconductor layer, may include one or more selected from the group consisting of ZnO, ZnGaO, ZnInO, ZnSnO, GaInZnO, CdO, InO, GaO, SnO, AgO, CuO, GeO, GdO, HfO, TiZnO, InGaZnO, and InTiZnO. However, this is an illustrative example, and the kind of oxide semiconductor is not limited thereto.

The data wring (DL, SE, DE) may be disposed on the semiconductor pattern layer 700. The data wring (DL, SE, DE) include a data line DL, a source electrode SE, and a drain electrode DE.

The data line DL may extend in a second direction, for example, the Y-axis direction of FIG. 2, and intersect the gate line GL. The source electrode SE may be branched from the data line DL to extend to the top of the semiconductor pattern layer 700.

The drain electrode DE may be spaced apart from the source electrode SE, and may be disposed on the semiconductor pattern layer 700 to face the source electrode SE with the gate electrode GE or the channel region CH therebetween. The drain electrode DE may be electrically connected to a pixel electrode PE to be described later.

The data wring (DL, SE, DE) may have a single film structure or a multi-film structure, made of nickel (Ni), cobalt (Co), titanium (Ti), silver (Ag), copper (Cu), molybdenum (Mo), aluminum (Al), beryllium (Be), niobium (Nb) Iron (Fe), selenium (Se), or tantalum (Ta). An alloy, which is formed by applying one or more elements selected from the group consisting of titanium (Ti), zirconium (Zr), tungsten (W), tantalum (Ta), niobium (Nb), platinum (Pt), hafnium (Hf), oxygen (O), and nitrogen (N) to the above metal, may be used. However, the above material is an illustrative example, and the material of the data wring (DL, SE, DE) is not limited thereto.

FIG. 2 illustrates a case where one thin film transistor is disposed in one pixel, but the scope of the present invention is not limited thereto. That is, in another embodiment, a plurality of thin film transistors may be disposed in one pixel. Further, when a plurality of thin film transistors is disposed in one pixel, one pixel may be divided into a plurality of domains so as to correspond to each of the thin film transistors.

A third insulation film or layer 130 may be disposed on the data wring (DL, SE, DE) and the semiconductor pattern layer 700. The third insulation layer 130 may be made of an inorganic insulating material or an organic insulating material.

The third insulation layer 130 may include a contact hole CNT exposing at least a part of the drain electrode DE.

A pixel electrode PE may be disposed on the third insulation layer 130. The pixel electrode PE may be electrically connected to the drain electrode DE through the contact hole CNT.

In an embodiment, the pixel electrode PE may be formed of a transparent conductor such as indium tin oxide (ITO) or indium zinc oxide (IZO) or a reflective conductor such as aluminum.

FIG. 2 illustrates a case where the pixel electrode PE has a flat plate shape, but the shape of the pixel electrode PE is not limited thereto. That is, in another embodiment, the pixel electrode may be a structure having one or more slits. Further, in another embodiment, one or more pixel electrodes may be arranged, and in this case, different voltages may be applied to the plurality of pixel electrodes.

A second substrate 1000 may be disposed to face the first substrate 500.

The second substrate 1000 may be formed of a material having heat resistance and light-transmitting properties. The material having heat resistance and light-transmitting properties may be, for example, glass or plastic.

A black matrix BM and a color filter CF may be disposed beneath the second substrate 1000.

The black matrix BM may extend in the first direction to overlap the aforementioned gate line GL, or may extend in the second direction to overlap the aforementioned data line DL.

Further, the black matrix BM may overlap the aforementioned thin film transistor.

The black matrix BM may block the light incident from the outside or prevent the light emitted from the inside. For this purpose, the black matrix BM may be formed of a photosensitive resin containing a black pigment. However, this is an illustrative example, and the material of the black matrix BM is not limited thereto. The material of the black matrix BM is not particularly limited as long as it is a material having physical properties necessary for blocking the light incident from the outside.

The color filter CF may be disposed at a region where the black matrix BM is not disposed. However, the color filter CF may partially overlap the black matrix BM.

The color filter CF may transmit light having a specific wavelength. In an embodiment, the color filter CF may include a red color filter CF_R, a green color filter CF_G, and a blue color filter CF_B (refer to FIG. 4).

The color filter CF may be disposed to overlap the photonic crystal unit PC. Details thereof will be described later with reference to FIG. 4.

Referring to FIG. 3 again, 3, an overcoat film OC may be disposed beneath the black matrix BM and the color filter CF. The overcoat film OC may include an organic or inorganic insulating material. The overcoat film OC may function as a planarization film.

Although FIG. 3 illustrates a case where the overcoat film OC is a single film, the present invention is not limited thereto. In another embodiment, the overcoat film OC may be a multiple film of two or more films. In another embodiment, the overcoat film OC may be omitted.

A common electrode CE may be disposed beneath the overcoat film OC. In an embodiment, the common electrode CE may be a non-patterned front electrode.

A common voltage may be applied to the common electrode CE. When different voltages are applied to the common electrode CE and the pixel electrode PE, a constant electric field may be formed between the common electrode CE and the pixel electrode PE.

A liquid crystal layer LC in which a plurality of liquid crystal molecules is arranged may be disposed between the second substrate 1000 and the first substrate 500. The liquid crystal layer LC may be controlled by an electric field formed between the common electrode CE and the pixel electrode PE, and may control the light necessary for displaying an image by controlling the movement of the liquid crystal molecules arranged in the liquid crystal layer LC.

A polarization plate POL may be disposed on the second substrate 1000. The polarization plate POL may transmit the light polarized in a specific direction in the light provided from the outside. The light polarized in other directions except the specific direction may be absorbed or reflected by the polarization plate POL. In an embodiment, the polarization plate POL may transmit light vibrating in the first direction, and may reflect or absorb light vibrating in the second direction. In an embodiment, the polarization direction of the polarization layer WGP may be different from that of the polarization plate. In other words, the transmission axis of the polarization plate POL and the transmission axis of the polarization layer WGP may be orthogonal to each other. That is, contrary to the polarization plate POL, the polarizing layer WGP may absorb or reflect light vibrating in the first direction, and may transmit light vibrating in the second direction.

In an embodiment, the polarization plate POL is configured to transmit light vibrating in the first direction, but may transmit a part of light vibrating in the second direction due to the limitation of optical filtering.

When the polarization layer WGP is configured to transmit light vibrating in the second direction, light vibrating in the second direction and passing through the polarization plate POL may be transmitted through the polarization layer WGP. Thus, the contrast ratio (CR) of the display device can be improved. The light vibrating in the first direction may be reflected by the polarization layer WGP to be used as a light source for expressing a color.

Subsequently, the photonic crystal unit PC and color filter CF of the reflective display device according to an exemplary embodiment will be described in more detail with reference to FIG. 4.

In an embodiment, the photonic crystal unit PC may include a red photonic crystal unit PC_R, a green photonic crystal unit PC_G, and a blue photonic crystal unit PC_B. In an embodiment, each of the red photonic crystal unit PC_R, a green photonic crystal unit PC_G, and a blue photonic crystal unit PC_B may be disposed to correspond to one pixel. That, the red photonic crystal unit PC_R may be disposed to correspond to a first pixel PX1, the green photonic crystal unit PC_G may be disposed to correspond to a second pixel PX2, and the blue photonic crystal unit PC_B may be disposed to correspond to a third pixel PX3.

The red photonic crystal unit PC_R may transmit light having a red wavelength. Light having a blue or green wavelength may be absorbed or reflected by the red photonic crystal unit PC_R.

The red photonic crystal unit PC_R may include a plurality of first nanopatterns NP1. The plurality of first nanopatterns NP1 may have a first pitch p1, and may be spaced apart from each other. In an embodiment, the first pitch p1 may be 380 nm to 450 nm.

When the plurality of first nanopatterns NP1 has the first pitch p1, the red photonic crystal unit PC_R may transmit light having a red wavelength.

In an embodiment, the first nanopattern NP1 may have a first thickness t1. The first thickness t1 may be 150 nm to 300 nm.

The green photonic crystal unit PC_G may transmit light having a green wavelength. Light having a red or blue wavelength may be absorbed or reflected by the green photonic crystal unit PC_G.

The green photonic crystal unit PC_G may include a plurality of second nanopatterns NP2. The plurality of second nanopatterns NP2 may have a second pitch p2, and may be spaced apart from each other. In an embodiment, the second pitch p2 may be 300 nm to 350 nm.

When the plurality of second nanopatterns NP2 has the second pitch p2, the green photonic crystal unit PC_G may transmit light having a green wavelength.

In an embodiment, the second nanopattern NP2 may have a second thickness t2. The second thickness t2 may be 150 nm to 300 nm.

The blue photonic crystal unit PC_B may transmit light having a blue wavelength. Light having a red or green wavelength may be absorbed or reflected by the blue photonic crystal unit PC_B.

The blue photonic crystal unit PC_B may include a plurality of third nanopatterns NP3. The plurality of third nanopatterns NP3 may have a third pitch p3, and may be spaced apart from each other. In an embodiment, the third pitch p3 may be greater than or equal to 250 nm and less than 300 nm.

When the plurality of third nanopatterns NP3 has the third pitch p2, the blue photonic crystal unit PC_B may transmit light having a blue wavelength.

In an embodiment, the third nanopattern NP3 may have a third thickness t3. The third thickness t3 may be 150 nm to 300 nm.

In an embodiment, the first thickness t1, the second thickness t2, and the third thickness t3 may be different from each other.

In an embodiment, the first thickness t1 may be the smallest, and the third thickness t3 may be the largest.

In another embodiment, the first thickness t1, the second thickness t2, and the third thickness t3 may be equal to each other.

In an embodiment, the first nanopattern NP1, the second nanopattern NP2, and the third nanopattern NP3 may at least partially overlap the pixel electrode PE of the first pixel PX1, the pixel electrode PE of the second pixel PX2, and the pixel electrode PE of the third pixel PX3, respectively.

In an embodiment, the color filter CF may include a red color filter CF_R, a green color filter CF_G, and a blue color filter CF_B.

The red color filter CF_R may transmit light having a red wavelength, the green color filter CF_G may transmit light having a green wavelength, and the blue color filter CF_B may transmit light having a blue wavelength.

In an embodiment, the red color filter CF_R may be disposed to overlap the red photonic crystal unit PC_R, the green color filter CF_G may be disposed to overlap the green photonic crystal unit PC_G, and the blue color filter CF_B may be disposed to overlap the blue photonic crystal unit PC_B.

Hereinafter, a method of operating the reflective display device according to an exemplary embodiment will be described.

The light provided from the outside may transmit through the polarization plate POL. That is, as described above, the polarization plate POL may transmit light vibrating in a specific direction.

The light having transmitted through the polarization plate POL may pass through any one of the red color filter CF_R, the green color filter CF_G, and the blue color filter CF_B.

First, a method of allowing the reflective display device to implement a red color will be described.

As described above, the light having passed through the red color filter CF_R may have a red wavelength. The light having passed through the red color filter CF_R may reach the red photonic crystal unit PC_R. As described above, the red photonic crystal unit PC_R may transmit light having a red wavelength. That is, the light having passed through the red color filter CF_R to have a red wavelength may reach the polarization layer WGP through the red photonic crystal portion PC_R. A part of the light having reached the polarization layer WGP may be reflected and proceed toward the second substrate 1000. That is, the light having reached the polarization layer WGP to have a red wavelength is reflected, and passes through the red photonic crystal unit PC_R and the red color filter CF_R, so as to allow a user to visually recognize a red color.

The implementation of a green color and a blue color may be substantially the same as the implementation of a red color described above. Therefore, a detailed description thereof will be omitted.

Subsequently, reflective display devices according to other exemplary embodiments will be described with reference to FIGS. 5 to 8.

FIG. 5 is a partial perspective view of a reflective display device according to another embodiment.

Referring to FIG. 5, a nanopattern NP4 may have a linear shape extending in one direction. In other words, the nanopattern NP4 may have a bar shape extending in a length direction.

The plurality of nanopatterns NP4 may be spaced apart from each other at regular intervals and may extend in parallel to each other.

In an embodiment, the extending direction of the plurality of nanopatterns NP4 may be parallel to the extending direction of the wire patterns WP.

The plurality of nanopatterns NP4 may be disposed to have a fourth pitch p4.

At least one selected from the first nanopattern NP1, the second nanopattern NP2 and the third nanopattern NP3, described with reference to FIG. 4, may have substantially the same shape as the nanopattern NP4 of FIG. 5. That is, the fourth pitch p4 may be substantially the same as any one of the first pitch p1-red-, the second pitch p2-green-, and the third p3-blue-, described with reference to FIG. 4, depending on the corresponding color.

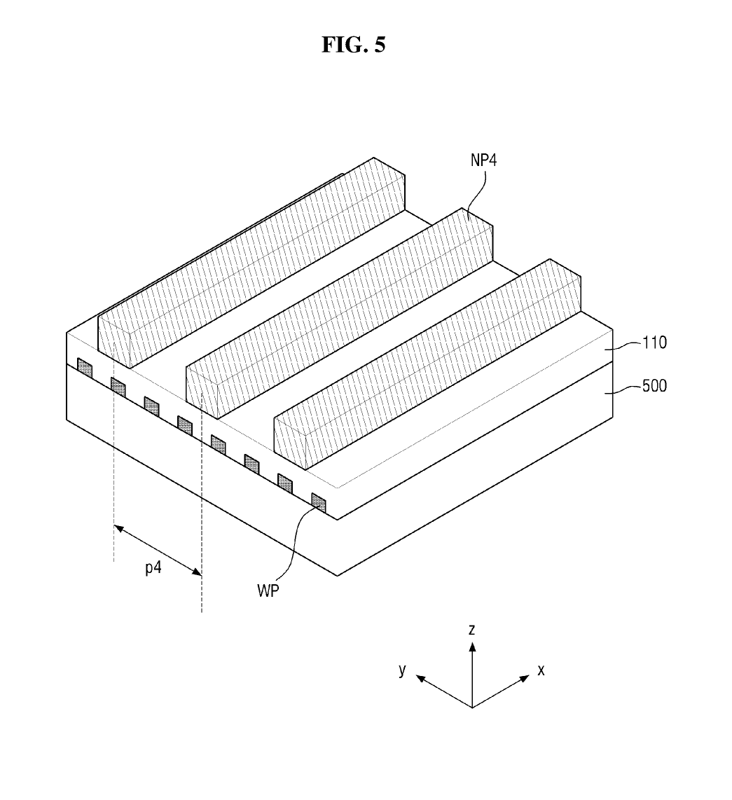

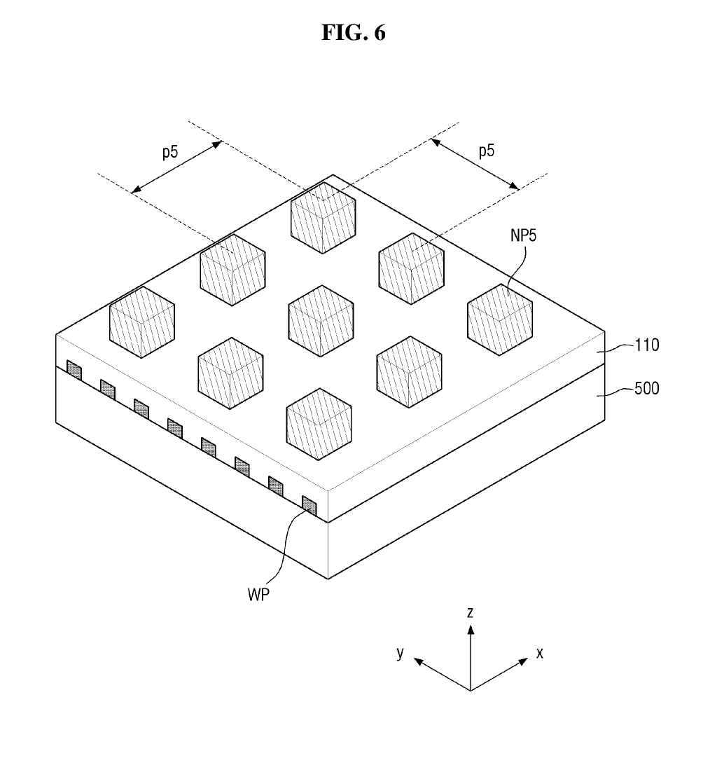

FIG. 6 is a partial perspective view of a reflective display device according to another embodiment.

Referring to FIG. 6, a nanopattern NP5 may have a rectangular parallelepiped shape. Further, the plurality of nanopatterns NP5 may be arranged in a matrix form having a plurality of rows and a plurality of column.

The plurality of nanopatterns NP5 may be disposed to have a fifth pitch p5. The fifth pitch p5, as shown in FIG. 6, may be defined between the nanopattern NP5 adjacent in the X-axis direction and the nanopattern NP5 adjacent in the Y-axis direction.

At least one selected from the first nanopattern NP1, the second nanopattern NP2 and the third nanopattern NP3, described with reference to FIG. 4, may have substantially the same shape as the nanopattern NP5 of FIG. 6. That is, the fifth pitch p5 may be substantially the same as any one of the first pitch p1-red-, the second pitch p2-green-, and the third p3-blue-, described with reference to FIG. 4, depending on the corresponding color.

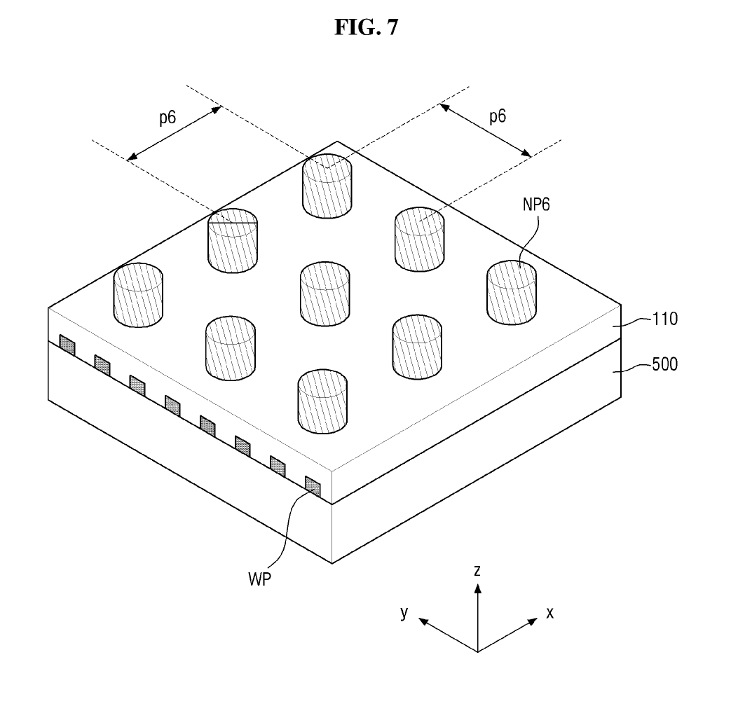

FIG. 7 is a partial perspective view of a reflective display device according to another embodiment.

Referring to FIG. 7, a nanopattern NP6 may have a cylindrical shape. Further, the plurality of nanopatterns NP6 may be arranged in a matrix form having a plurality of rows and a plurality of column.

The plurality of nanopatterns NP6 may be disposed to have a sixth pitch p6. The sixth pitch p6, as shown in FIG. 7, may be defined between the nanopattern NP6 adjacent in the X-axis direction and the nanopattern NP6 adjacent in the Y-axis direction.

At least one selected from the first nanopattern NP1, the second nanopattern NP2 and the third nanopattern NP3, described with reference to FIG. 4, may have substantially the same shape as the nanopattern NP6 of FIG. 7. That is, the sixth pitch p6 may be substantially the same as any one of the first pitch p1-red-, the second pitch p2-green-, and the third p3-blue-, described with reference to FIG. 4, depending on the corresponding color.

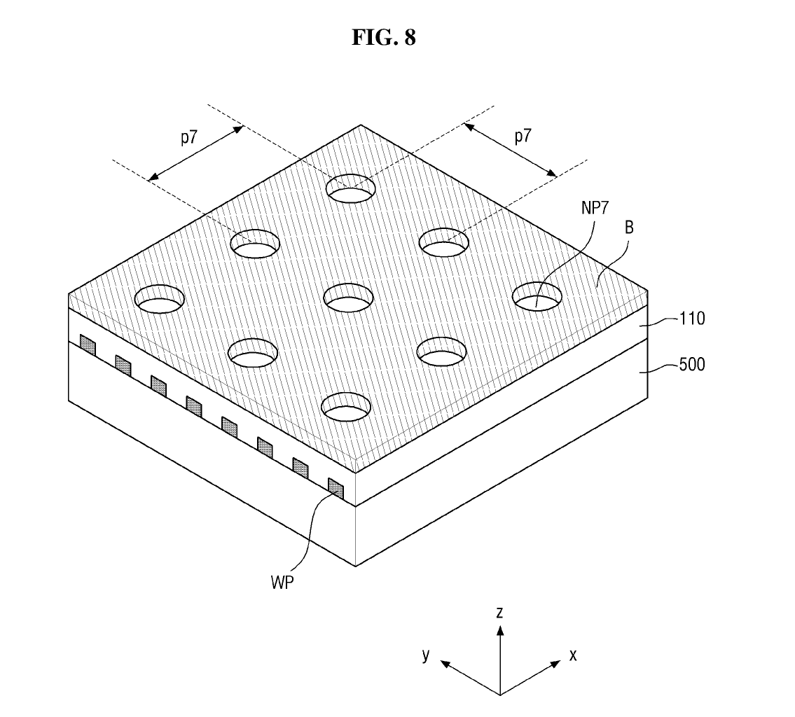

FIG. 8 is a partial perspective view of a reflective display device according to another embodiment.

In an embodiment, a nanopattern NP7 may be formed by engraving. That is, unlike the embossed patterns of FIGS. 5 to 7, the nanopattern NP7 may be an engraved pattern.

The nanopattern NP7, which is an engraved pattern, may be formed by recessing from a base layer B.

That is, an empty space that is recessed from the base layer B may form the nanopattern NP7.

Although FIG. 8 illustrates a case where the nanopattern NP7 has a cylindrical shape, the shape of the nanopattern NP7 is not limited thereto. In another embodiment, the nanopattern NP7 may have a rectangular parallelepiped shape.

The plurality of nanopatterns NP7 may be disposed to have a seventh pitch p7. The seventh pitch p7, as shown in FIG. 8, may be defined between the nanopattern NP7 adjacent in the X-axis direction and the nanopattern NP7 adjacent in the Y-axis direction.

At least one selected from the first nanopattern NP1, the second nanopattern NP2 and the third nanopattern NP3, described with reference to FIG. 4, may have substantially the same shape as the nanopattern NP7 of FIG. 8. That is, the seventh pitch p7 may be substantially the same as any one of the first pitch p1-red-, the second pitch p2-green-, and the third p3-blue-, described with reference to FIG. 4, depending on the corresponding color.

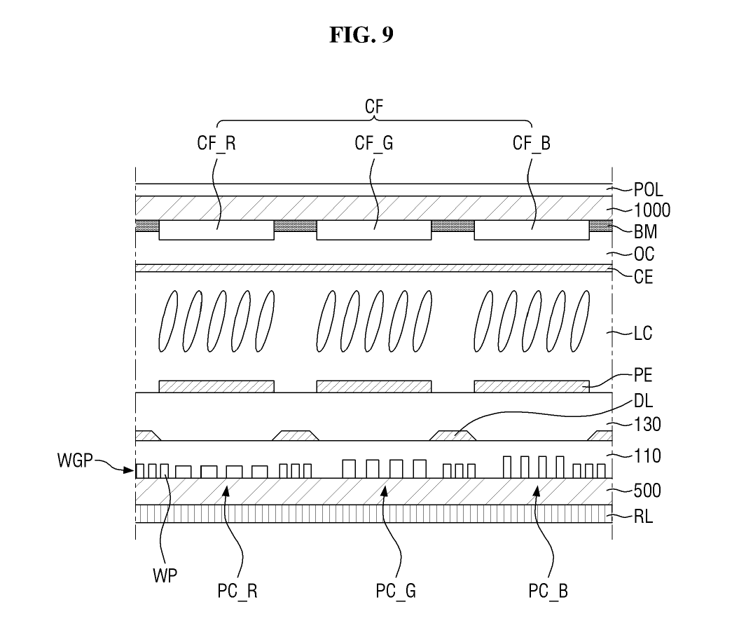

FIG. 9 is a sectional view of a reflective display device according to another embodiment.

Referring to FIG. 9, in another embodiment, the photonic crystal unit PC and the polarization layer WGP may be formed on the same layer.

In other words, the photonic crystal unit PC and the polarization layer WGP may be disposed on the first substrate 500.

Specifically, a red photonic crystal unit PC_R, a green photonic crystal unit PC_G, and a blue photonic crystal unit PC_B may be disposed on the first substrate 500.

In an embodiment, a plurality of wire patterns WP may be formed between the plurality of photonic crystal units PC.

When the photonic crystal unit PC and the polarization layer WGP are formed on the same layer, the thickness of the reflective display device can be reduced.

In an embodiment, a reflective layer RL may be further disposed beneath the first substrate 500.

Any material having a performance or structure reflecting light may be used in forming the reflective layer RL. That is, the material of the reflective layer RL is not particularly limited.

In the embodiment of FIG. 9, the light reflected by the polarization layer WGP cannot pass through the photonic crystal unit PC (because the photonic crystal unit PC and the polarization layer WGP are formed on the same layer). When the reflective layer RL is disposed beneath the first substrate 500, the light having passed through the polarization layer WGP may proceed toward the second substrate 1000 again. That is, the light that is reflected and proceeds toward the second substrate 1000 can pass through the photonic crystal unit PC and color filter CF having the same color, and thus a user can visually recognize any one of red, green and blue colors.

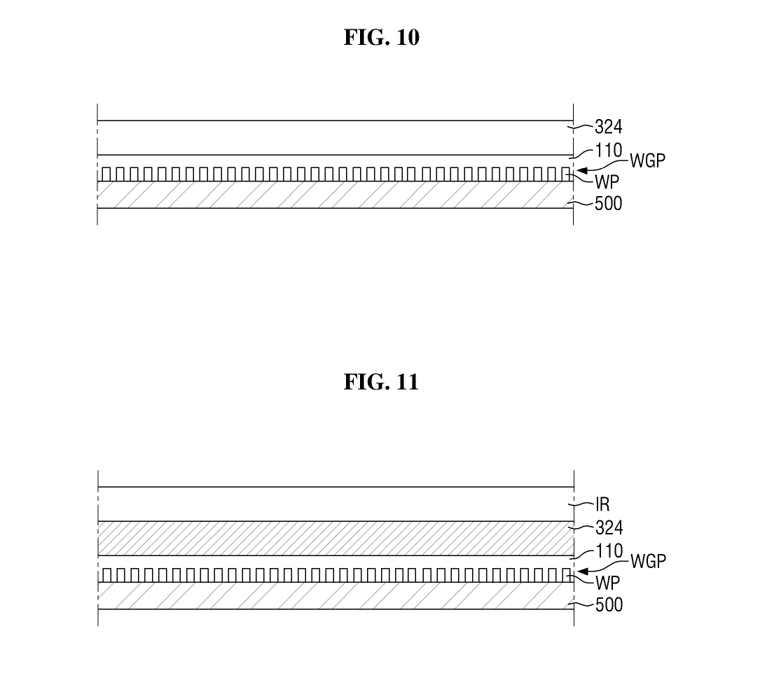

Hereinafter, a method of manufacturing a reflective display device according to an exemplary embodiment will be described with reference to FIGS. 10 to 16.

FIGS. 10 to 16 are sectional views illustrating a method of manufacturing a reflective display device according to an exemplary embodiment.

Referring to FIGS. 10 to 16, a method of manufacturing a reflective display device according to an exemplary embodiment includes the steps of: forming or otherwise disposing a material layer 324 over a substrate 500 provided with a polarization layer WGP including a plurality of wire patterns WP; applying an imprint resin IR onto the material layer 324; pressing the imprint resin IR using a mask mold MM including a first protrusion PP1, a second protrusion PP2, and a third protrusion PP3 having different pitches from each other to pattern the imprint resin IR; etching the patterned imprint resin IR to form a resin mask IM1; and etching the material layer 324 using the resin mask IM1 as an etch stop film to form a photonic crystal unit PC.

Referring to FIG. 10, a step of forming a material layer 324 over a substrate 500 provided with a polarization layer WGP including a plurality of wire patterns WP may proceed. The wire patterns WP and the polarizing layer WGP may be substantially the same as those described in the reflective display device according to some embodiments of the present invention. Therefore, a detailed description thereof will be described.

A first insulation film 110 may be formed on the polarization layer WGP. The first insulation film 110 may be formed by chemical vapor deposition or sputtering.

A material layer 324 may be formed on the first insulation film 110. The material layer 324, which is a layer becoming a material of a photonic crystal unit PC to be described later, may be made of the same material as the aforementioned photonic crystal unit PC.

Specifically, the material layer may be made of one or more selected from Si, SiC, ZnS, AlN, BN, GaTe, AgI, TiO₂, and SiON.

Subsequently, referring to FIG. 11, a step of applying an imprint resin IR onto the material layer 324 may proceed.

The imprint resin IR may include a resin, and the like. In an embodiment, the imprint resin IR may include silicon nitride or silicon oxide.

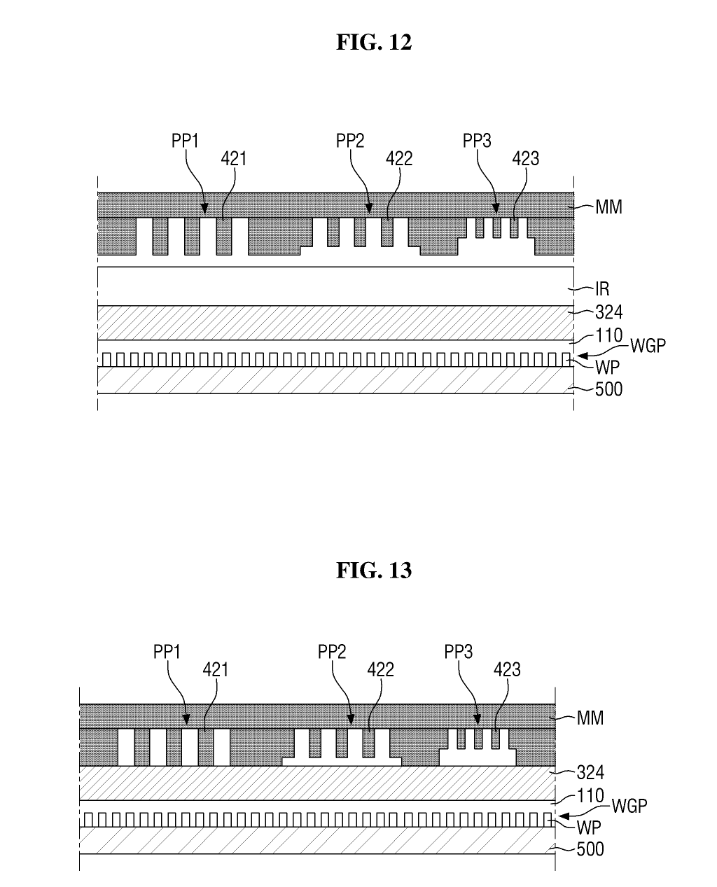

Subsequently, referring to FIGS. 12 and 13, a step of pressing the imprint resin IR using a mask mold MM including a first protrusion PP1, a second protrusion PP2, and a third protrusion PP3 having different pitches from each other may proceed.

The mask mold MM may include a first protrusion PP1, a second protrusion PP2, and a third protrusion PP3. The first protrusion PP1, the second protrusion PP2, and the third protrusion PP3 may have different pitches from each other. Therefore, a first mask M1, a second mask M2, and a third mask M3, which will be formed corresponding to the first protrusion PP1, the second protrusion PP2, and the third protrusion PP3, may also have different pitches from each other.

The first protrusion PP1 may include a plurality of first protrusion patterns 421. The plurality of first protrusion patterns 421 may be spaced apart from each other and arranged in parallel to each other.

The second protrusion PP2 may include a plurality of second protrusion patterns 422. The plurality of second protrusion patterns 422 may be spaced apart from each other and arranged in parallel to each other.

The third protrusion PP3 may include a plurality of third protrusion patterns 423. The plurality of third protrusion patterns 423 may be spaced apart from each other and arranged in parallel to each other.

Subsequently, referring to FIG. 13, the mask mold MM moves toward the substrate 500 to press the imprint resin IR. The imprint resin IR may be patterned by the protrusions formed on the mask mold MM. In other words, the patterned imprint resin IR may have patterns complementary to the protrusions of the mask mold MM.

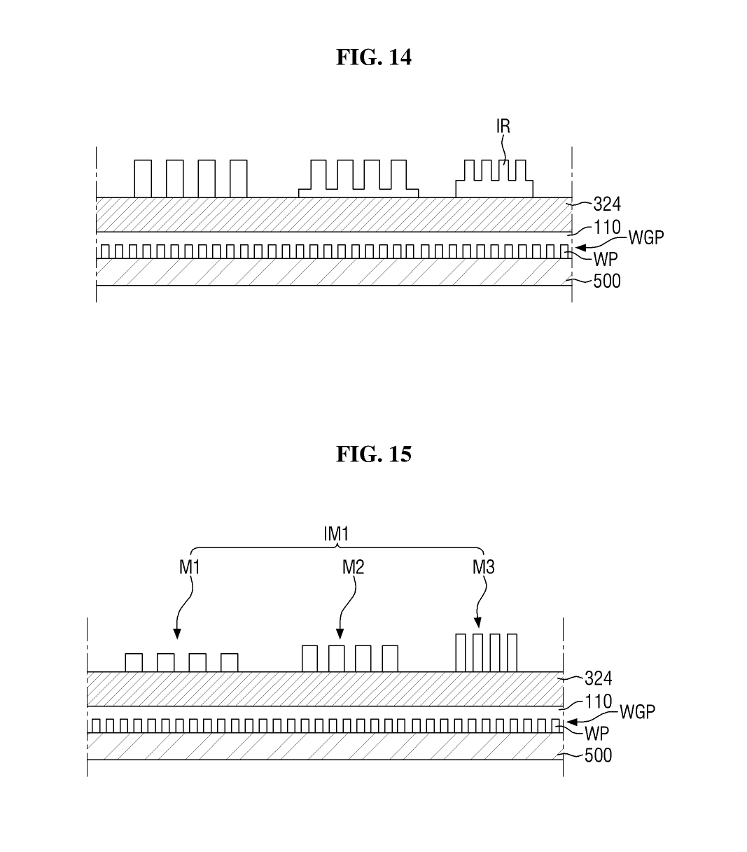

Subsequently, referring to FIG. 14, the patterned imprint resin IR may be disposed on the first insulation film 110. A step of etching the patterned imprint resin IR in order to form a resin mask IM1 may proceed. Since the patterned imprint resin IR may include a residual film between the patterns, the residual film may be removed by etching to form the resin mask IM1.

Referring to FIG. 15, the resin mask IM1 may include a first mask M1, a second mask M2, and a third mask M3.

In an embodiment, the first mask M1 may have a first pitch p1, the second mask M2 may have a second pitch p2, and the third mask M3 may have a third pitch p3.

In an embodiment, the first mask M1 may become a mask for forming a red photonic crystal unit PC_R, the second mask M2 may become a mask for forming a green photonic crystal unit PC_G, and the third mask M3 may become a mask for forming a blue photonic crystal unit PC_B.

In this case, the first pitch p1 of the first mask M1 may be 380 nm to 450 nm, which is the same as the pitch of the red photonic crystal portion PC_R.

Similarly, the second pitch p2 of the second mask M2 may be 300 nm to 350 nm, which is the same as the pitch of the green photonic crystal portion PC_G.

Further, the third pitch p3 of the third mask M3 may be greater than or equal to 250 nm and less than 300 nm, which is the same as the pitch of the blue photonic crystal portion PC_B.

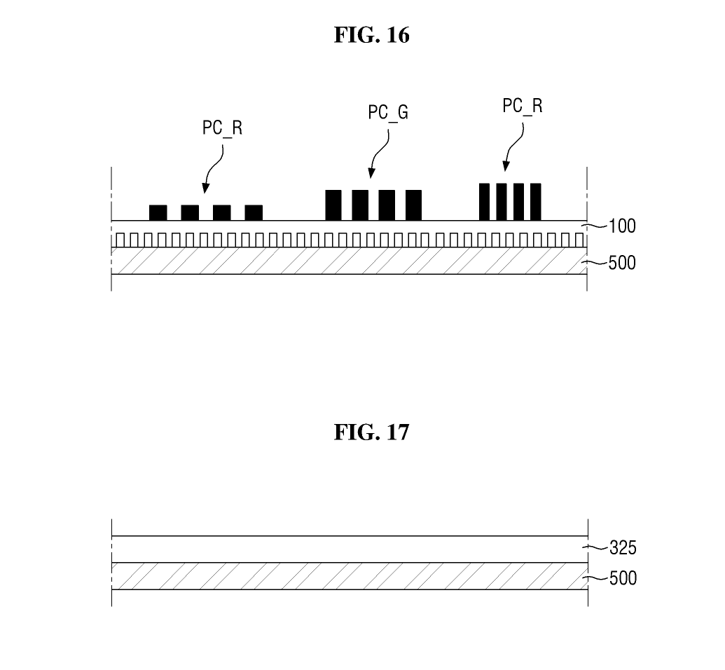

Subsequently, referring to FIG. 16, a step of etching the material layer 324 using the resin mask IM1 as an etch stop film to form a photonic crystal unit PC may proceed.

The material layer 324 may be etched by using the resin mask IM1 as an etch stop film. In an embodiment, the etching of the material layer 324 may be performed by dry etching.

In an embodiment, the thicknesses of the first mask M1, the second mask M2 and the third mask M3 may be different from each other. Accordingly, the thicknesses of the red photonic crystal unit PC_G, the green photonic crystal unit PC_G, and the blue photonic crystal unit PC_B, which are the resultant products of the etching, may be different from each other, as described above.

The red photonic crystal unit PC_G, the green photonic crystal unit PC_G, and the blue photonic crystal unit PC_B, which are the resultant products of the etching, may be substantially the same as those described in the reflective display device according to some embodiments of the present invention. Therefore, a detailed description thereof will be omitted.

Hereinafter, a method of manufacturing a reflective display device according to another exemplary embodiment will be described with reference to FIGS. 17 to 20. FIGS. 17 to 20 are sectional views illustrating a method of manufacturing a reflective display device according to another exemplary embodiment.

Referring to FIGS. 17 to 20, a method of manufacturing a reflective display device according to another exemplary embodiment includes the steps of: forming or otherwise disposing a material layer 325 on a substrate 500; applying an imprint resin IR onto the material layer 325; pressing the imprint resin IR using a mask mold MM including a first protrusion PP1, a second protrusion PP2, and a third protrusion PP3 having different pitches from each other to pattern the imprint resin IR; etching the patterned imprint resin IR to form a resin mask IM2; and etching the material layer 325 using the resin mask IM2 as an etch stop film to form a photonic crystal unit PC and wire pattern WP.

Referring to FIG. 17, a step of forming a material layer 325 on a substrate 500 may proceed. The material layer 325 may become a material of the wire patterns WP and photonic crystal unit PC described with reference to FIG. 9. Accordingly, the material layer 325 may include the same material as the wire patterns WP and photonic crystal unit PC described in the reflective display device according to some embodiments of the present invention.

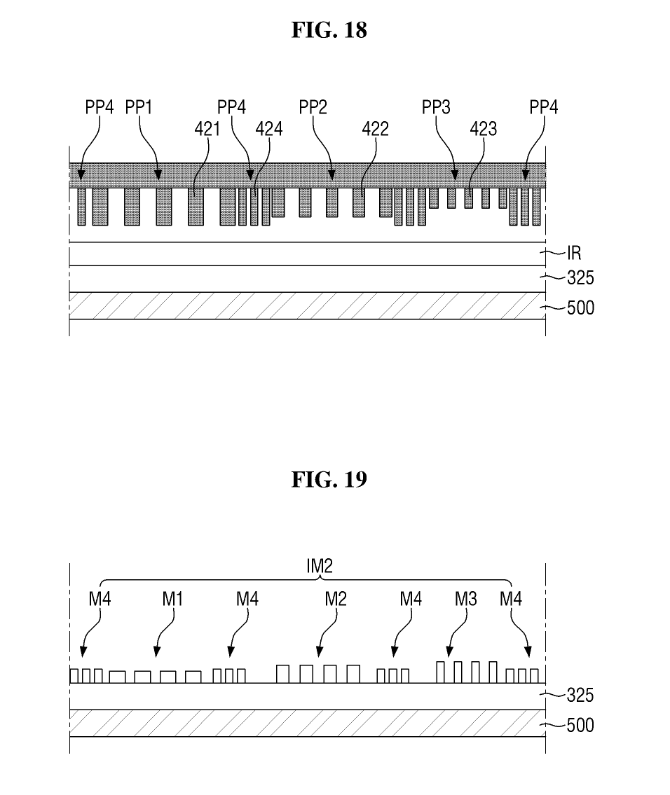

Subsequently, referring to FIG. 18, a step of pressing the imprint resin IR using a mask mold MM including a first protrusion PP1, a second protrusion PP2, and a third protrusion PP3, having different pitches from each other. The first protrusion PP1, the second protrusion PP2, and the third protrusion PP3 may be substantially the same as those described in the aforementioned method of manufacturing the reflective display device according to an exemplary embodiment.

In the mask mold MM, a fourth protrusion PP4 may be formed in a region other than the regions where the first protrusion PP1, the second protrusion PP2, and the third protrusion PP3 are formed. The fourth protrusion pp4, which is a structure for forming a fourth mask M4 for forming wire patterns WP to be described later, may include a plurality of fourth protrusion patterns 424. The plurality of fourth protrusion patterns 424 may be spaced apart from each other and may extend in parallel to each other.

Subsequently, a step of pressing the imprint resin IR using the mask mold MM to pattern the imprint resin IR and a step of etching the patterned imprint resin IR to form a resin mask IM2 may proceed.

The step of pressing the imprint resin IR using the mask mold MM and the step of etching the patterned imprint resin IR to form the resin mask IM2 may be substantially the same as those described above with reference to FIGS. 12 to 14. Therefore, a detailed description thereof will be omitted.

Subsequently, referring to FIG. 19, a step of etching the patterned imprint resin IR to form a resin mask IM2 may proceed.

In an embodiment, the resin mask IM2 may include a first mask M1, a second mask M2, a third mask M3, and a fourth mask M4. The first mask M1, the second mask M2, and the third mask M3 may be substantially the same as those described above with reference to FIG. 15. The fourth mask M4 may be formed in a region other than the regions where the first mask M1, the second mask M2, the third mask M3 are formed. The fourth mask M4 may be a mask for forming wire patterns WP. In an embodiment, the fourth mask M4 may have a fourth pitch p4. The fourth pitch p4 may be 80 nm to 500 nm.

In an embodiment, the fourth mask M4 may be formed between the first mask M1 and the second mask M2 and between the second mask M2 and the third mask M3.

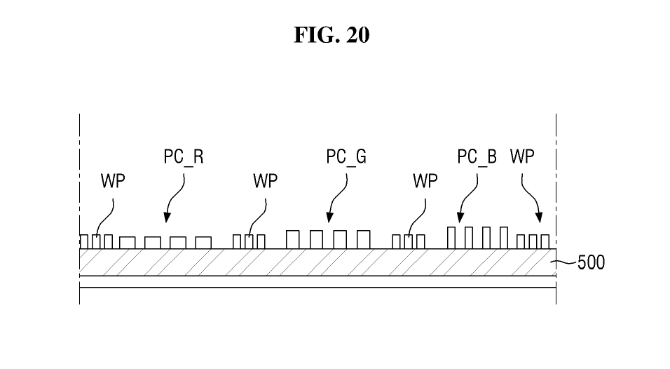

Subsequently, referring to FIG. 20, a step of etching the material layer 325 using the resin mask IM2 as an etch stop film to form a photonic crystal unit PC and wire patterns WP may proceed.

The material layer 325 may be etched by using the resin mask IM2 as an etch stop film. In an embodiment, the etching of the material layer 325 may be performed by dry etching.

A red photonic crystal unit PC_R, a green photonic crystal unit PC_G, and a blue photonic crystal unit PC_B may be formed at positions corresponding to the first mask M1, the second mask M2, and the third mask M3. Further, wire patterns WP may be formed at a position corresponding to the fourth mask M4.

In an embodiment, the thicknesses of the first mask M1, the second mask M2 and the third mask M3 may be different from each other. Accordingly, the thicknesses of the red photonic crystal unit PC_G, the green photonic crystal unit PC_G, and the blue photonic crystal unit PC_B, which are the resultant products of the etching, may be different from each other, as described above.

The red photonic crystal unit PC_G, the green photonic crystal unit PC_G, the blue photonic crystal unit PC_B, and the wire patterns WP, which are the resultant products of the etching, may be substantially the same as those described in the reflective display device according to the embodiment of FIG. 9. Therefore, a detailed description thereof will be omitted. That is, the result products of the method of manufacturing a reflective display device according to an exemplary embodiment may be the reflective display device according to the embodiment of FIG. 9.

The method of manufacturing a reflective display device according to an exemplary embodiment may further include a step of forming a reflective layer RL beneath the first substrate 500. The order of the step of forming the reflective layer RL may not be limited. That is, the step of forming the reflective layer RL may be performed before or after each of the above steps is performed.

As described above, according to the exemplary embodiments, there can be provided a reflective display device having an excellent contrast ratio.

Further, there can be provided a reflective display device having excellent color reproducibility.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A reflective display device, comprising:
a first substrate;
a polarization layer disposed on the first substrate and comprising a plurality of wire patterns; and
a photonic crystal unit comprising a plurality of nanopatterns arranged over the first substrate at predetermined pitches.

2. The reflective display device of claim 1, further comprising:
a first insulation film covering the polarization layer,
wherein the photonic crystal unit is disposed on the first insulation film.

3. The reflective display device of claim 1,
wherein the photonic crystal unit comprises a red photonic crystal unit, a green photonic crystal unit, and a blue photonic crystal unit.

4. The reflective display device of claim 3,
wherein the red photonic crystal unit comprises a plurality of first nanopatterns arranged to have a first pitch, the green photonic crystal unit comprises a plurality of second nanopatterns arranged to have a second pitch, and the blue photonic crystal unit comprises a plurality of third nanopatterns arranged to have a third pitch.

5. The reflective display device of claim 4,
wherein the first pitch is 380 nm to 450 nm, the second pitch is 300 nm to 350 nm, and the third pitch is greater than or equal to 250 nm and less than 300 nm.

6. The reflective display device of claim 4,
wherein heights of the first nanopattern, the second nanopattern, and the third nanopattern are different from each other.

7. The reflective display device of claim 3,
wherein the red photonic crystal unit transmits light having a red wavelength, the green photonic crystal unit transmits light having a green wavelength, and the blue photonic crystal unit transmits light having a blue wavelength.

8. The reflective display device of claim 1,
wherein each nanopattern has a thickness of 150 nm to 300 nm.

9. The reflective display device of claim 1,
wherein each nanopattern has a bar shape extending in one direction.

10. The reflective display device of claim 1,
wherein the nanopatterns are arranged in a matrix form having a plurality of rows and a plurality of columns.

11. The reflective display device of claim 1,
wherein each nanopattern is an engraved nanopattern.

12. The reflective display device of claim 1, further comprising:
a second substrate facing the first substrate; and
a polarization plate formed on the second substrate,
wherein polarization directions of the polarization plate and the polarization layer are different from each other.

13. The reflective display device of claim 1, further comprising:
a color filter disposed over the first substrate,
wherein the color filter overlaps the photonic crystal unit.

14. The reflective display device of claim 1,
wherein the wire patterns and the photonic crystal unit are disposed on the same layer.

15. The reflective display device of claim 14, further comprising: a reflective layer disposed beneath the first substrate.

16. A method of manufacturing a reflective display device, comprising:
disposing a material layer over a substrate provided with a polarization layer comprising a plurality of wire patterns;
applying an imprint resin onto the material layer;
pressing the imprint resin using a mask mold comprising a first protrusion, a second protrusion, and a third protrusion having different pitches from each other to pattern the imprint resin;
etching the patterned imprint resin to form a resin mask; and
etching the material layer using the resin mask as an etch stop film to form a photonic crystal unit.

17. The method of claim 16,
wherein the resin mask comprises a first mask having a first pitch, a second mask having a second pitch, and a third mask having a third pitch.

18. A method of manufacturing a reflective display device, comprising:
disposing a material layer on a first substrate;
applying an imprint resin onto the material layer;
pressing the imprint resin using a mask mold comprising a first protrusion, a second protrusion, and a third protrusion having different pitches from each other to pattern the imprint resin;
etching the patterned imprint resin to form a resin mask; and
etching the material layer using the resin mask as an etch stop film to form a photonic crystal unit and wire patterns.

19. The method of claim 18, further comprising:
disposing a reflective layer beneath the first substrate.

20. The method of claim 18,
wherein the resin mask comprises a first mask having a first pitch, a second mask having a second pitch, a third mask having a third pitch, and a fourth mask having a fourth pitch.
